(19) United States
(12) Patent Application Publication
(10) Pub. No.: US 2023/0262292 A1
(43) Pub. Date: Aug. 17, 2023

(54) CONTENT PLAYING METHOD AND SYSTEM

(71) Applicant: NAVER CORPORATION, Seongnam-si (KR)

(72) Inventors: Jonghyeok LEE, Seongnam-si (KR); Hyo Won HWANG, Seongnam-si (KR); Woo-sik BYUN, Seongnam-si (KR); SungTaek CHO, Seongnam-si (KR); SungHo KIM, Seongnam-si (KR); Joon-kee CHANG, Seongnam-si (KR)

(21) Appl. No.: 18/301,411

(22) Filed: Apr. 17, 2023

Related U.S. Application Data
(63) Continuation of application No. PCT/KR2021/014545, filed on Oct. 19, 2021.

(30) Foreign Application Priority Data
Oct. 19, 2020 (KR) 10-2020-0135381

(51) Int. Cl. H04N 21/472; H04N 21/858; H04N 21/262

(52) U.S. Cl. CPC H04N 21/47202; H04N 21/8586; H04N 21/26258

(57) ABSTRACT

A content playing method includes obtaining a first media playlist for video on demand (VOD)-type first content via a server in accordance with a request from a player; changing the obtained first media playlist from VOD-type to live-type; providing the changed first media playlist to the player; obtaining a second media playlist for second content via the server, before the completion of the playing of the first content using the changed first media playlist in the player; and generating a third media playlist by connecting the changed first media playlist and the second media playlist.

### CROSS-REFERENCE TO RELATED APPLICATIONS

This is a continuation application of International Application No. PCT/KR2021/014545, filed Oct. 19, 2021, which claims the benefit of Korean Patent Application No. 10-2020-0135381, filed Oct. 19, 2020.

### BACKGROUND OF THE INVENTION

### Field of Invention

One or more example embodiments of the present invention in the following description relate to a content playback method and system.

### Description of Related Art

Existing solutions for playback of streaming content include, for example, HTTP Live Streaming (HLS), Moving Picture Experts Group-Dynamic Adaptive Streaming over HTTP (MPEG-DASH), mp4, and the like.

Here, in the case of general video on demand (VOD) playback, when consecutively playing back two VODs, it is difficult to exactly match playback timings of two pieces of content, making it difficult to play back the VODs in a gapless manner.

### BRIEF SUMMARY OF THE INVENTION

One or more example embodiments of the present invention provide a content playback method and system that may gaplessly play back at least two pieces of content each provided in a streaming manner as one piece of content.

According to at least one example embodiment, there is provided a content playback method of a computer device comprising at least one processor, the content playback method comprising acquiring, by the at least one processor, a first media playlist for first content of a video-on-demand (VOD) type through a server in response to a request from a player; modifying, by the at least one processor, the acquired first media playlist from the VOD type to a live type; providing, by the at least one processor, the changed first media playlist to the player; acquiring, by the at least one processor, a second media playlist for second content through a server before playback of the first content using the modified first media playlist in the player ends; and generating, by the at least one processor, a third media playlist by connecting the second media playlist to the modified first media playlist.

According to an aspect of the invention, the player may be configured to periodically request the first media playlist when playing back the first content upon receiving the first media playlist of the live type.

According to another aspect, the content playback method may further comprise providing, by the at least one processor, the modified first media playlist in response to a periodic request from the player and providing the third media playlist after acquiring the second media playlist.

According to still another aspect, the modifying of the acquired first media playlist may comprise removing a tag representing an end of the first media playlist from the first media playlist; adding a tag specifying that the first media playlist is the live type to the first media playlist; and changing a path of streaming data included in the first media playlist to an absolute path that includes a default uniform resource locator (URL).

According to still another aspect, the generating of the third media playlist may comprise generating the third media playlist that includes first contents of the modified first media playlist and second contents of the second media playlist and adding a tag specifying that a timeline is changed between the first contents and the second contents.

According to still another aspect, the server that provides the first media playlist and the server that provides the second media playlist may be different servers.

According to at least one example embodiment, there is provided a computer program stored in a computer-readable recording medium to implement the content playback method on a computer device in conjunction with the computer device.

According to at least one example embodiment, there is provided a computer-readable recording medium storing a program to implement the content playback method on a computer device.

According to at least one example embodiment, there is provided a computer device comprising at least one processor configured to execute computer-readable instructions for performing content playback. The at least one processor causes the computer device to acquire a first media playlist for first content of a VOD type through a server in response to a request from a player, to modify the acquired first media playlist from the VOD type to a live type, to provide the modified first media playlist to the player, to acquire a second media playlist for second content through a server before playback of the first content using the modified first media playlist in the player ends, and to generate a third media playlist by connecting the second media playlist to the modified first media playlist.

According to some example embodiments, it is possible to gaplessly play back at least two pieces of content each provided in a streaming manner as one piece of content.

### BRIEF DESCRIPTION OF THE DRAWINGS

FIG. 1 is a diagram illustrating an example of a network environment according to an example embodiment.

FIG. 2 is a diagram illustrating an example of a computer device according to an example embodiment.

FIG. 3 illustrates an example of a general video on demand (VOD) playback.

FIG. 4 illustrates an example of a process of providing streaming content according to an example embodiment;

FIG. 5 illustrates an example of modifying a media playlist to change VOD-type content to live-type content according to an example embodiment.

FIG. 6 illustrates an example of two pieces of content connected as one piece of content according to an example embodiment.

FIG. 7 illustrates an example of a connected media playlist according to an example embodiment.

FIG. 8 is a flowchart illustrating an example of a content playback method according to an example embodiment.

### DETAILED DESCRIPTION OF THE INVENTION

Hereinafter, some example embodiments will be described with reference to the accompanying drawings.

A content playback system according to the example embodiments may be implemented by at least one computer device and a content playback method according to the example embodiments may be performed by at least one computer device included in the content playback system. Here, a computer program according to an example embodiment may be installed and executed on the computer device, and the computer device may perform the content playback method according to the example embodiments under the control of the executed computer program. The aforementioned computer program may be stored in a computer-readable storage medium to computer-implement the content playback method in conjunction with the computer device.

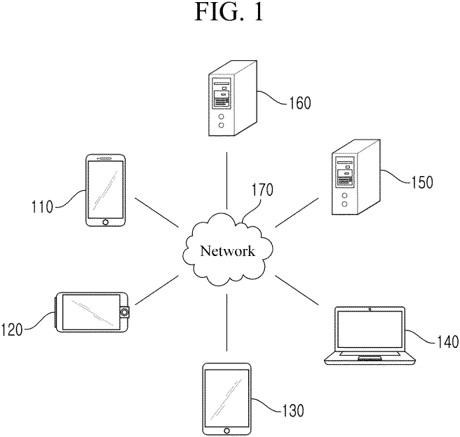

FIG. 1 illustrates an example of a network environment according to an example embodiment. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as an example only among environments applicable to the example embodiments and the environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), and the like. For example, although FIG. 1 illustrates a shape of a smartphone as an example of the electronic device 110, the electronic device 110 used herein may refer to one of various types of physical computer devices capable of communicating with other electronic devices 120, 130, and 140 and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, and a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., a content providing service, a group call service (or an audio conference service), a messaging service, a mail service, a social network service, a map service, a translation service, a financial service, a payment service, a search service, etc.) to the plurality of electronic devices 110, 120, 130, and 140 connected over the network 170.

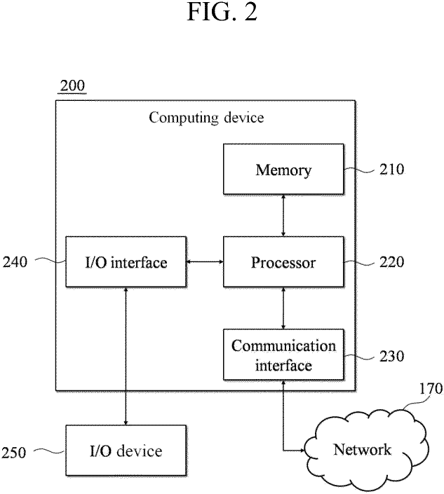

FIG. 2 is a block diagram illustrating an example of a computer device according to an example embodiment. Each of the plurality of electronic devices 110, 120, 130, and 140 of FIG. 1 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a computer-readable recording medium. The permanent mass storage device, such as ROM and a disk drive, may be included in the computer device 200 as a permanent storage device separate from the memory 210. Also, an operating system (OS) and at least one program code may be stored in the memory 210. Such software components may be loaded to the memory 210 from another computer-readable recording medium separate from the memory 210. The other computer-readable recording medium may include a computer-readable recording medium, for example, a floppy drive, a disk, a tape, a DVD/CD-ROM drive, a memory card, etc. According to other example embodiments, software components may be loaded to the memory 210 through the communication interface 230, instead of the computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the communication apparatus 200 and another apparatus (e.g., the aforementioned storage devices) over the network 170. For example, the processor 220 of the computer device 200 may deliver a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the network 170 and the communication interface 230 of the computer device 200. For example, a signal, an instruction, data, etc., received through the communication interface 230 may be delivered to the processor 220 or the memory 210, and a file, etc., may be stored in a storage medium (e.g., the permanent storage device) further includable in the computer device 200.

The I/O interface 240 may be a device used for interfacing with an I/O device 250. For example, an input device of the I/O device 250 may include a device, such as a microphone, a keyboard, a mouse, etc., and an output device of the I/O device 250 may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include greater or less number of components than those shown in FIG. 2. For example, the computer device 200 may include at least a portion of the I/O device 250, or may further include other components, for example, a transceiver, a database, etc.

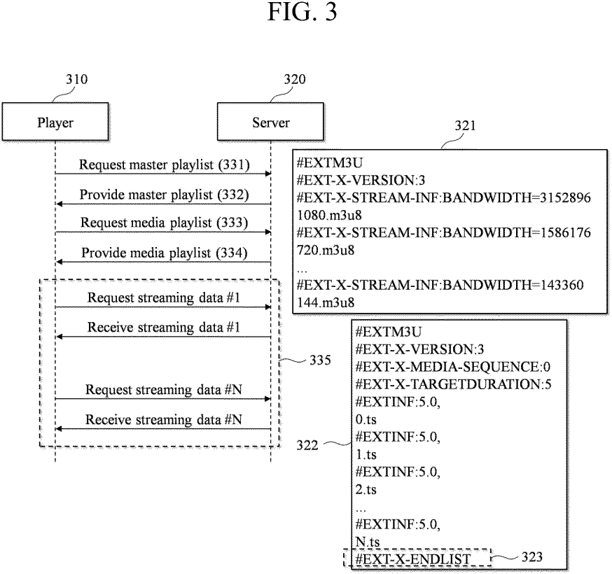

FIG. 3 illustrates an example of a general VOD playback.

A player 310 may request a server 320 for a master playlist (e.g., master.m3u8 of HTTP Live Streaming (HLS) protocol) for specific content (331). In this case, the server 320 may provide the requested master playlist to the player 310 (332).

Then, the player 310 may select a media playlist (e.g., playlist.m3u8 of HLS protocol) corresponding to specific screen quality through the master playlist and may request the server 320 for the selected media playlist (333). In this case, the server 330 may provide the requested media playlist to the player 310 (334).

Here, the player 310 may sequentially request and receive N pieces of streaming data (e.g., ts file of HLS protocol) from the server 320 through the media playlist (335). The received streaming data may be sequentially played back in the player 310.

Meanwhile, FIG. 3 illustrates an example 321 of the master playlist and an example 322 of the media playlist that are provided from the server 320 to the player 310. Here, if the media playlist includes tag #EXT-X-ENDLIST 323 as in the example 322 of the media playlist, the player 310 may sequentially play back all content chunks (e.g., 0. ts file to N.ts file) without monitoring the master playlist (e.g., playlist.m3u8). In this case, when consecutively playing back two pieces of content, it is difficult to exactly match the timings of the two pieces of content (playback end timing of first content and playback start timing of second content), making gapless playback between the two pieces of content difficult.

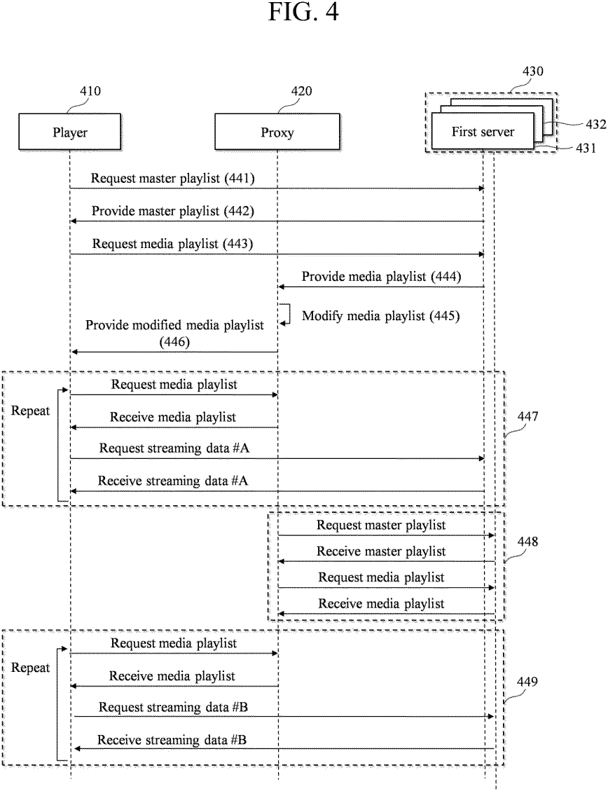

FIG. 4 illustrates an example of a process of providing streaming content according to an example embodiment. FIG. 4 illustrates a player 410, a proxy 420, and a plurality of servers 430. Here, the player 410 and the proxy 420 may be software modules installed and running on a terminal device (e.g., electronic device 110, 120, 130 or 140) of a user for playback of streaming content. Also, each of the plurality of servers 430 may be a software module installed and running on a server device (e.g., server 150 or 160) to provide a streaming service. Here, the software module may correspond to a computer program installed and running on the computer device 200.

A first process 441 may be an example of a process in which a player 410 requests a first server 431 for a master playlist of first content through a proxy 420. The first server 431 may be one of a plurality of servers 430.

A second process 442 may be an example of a process in which the first server 431 provides the master playlist of the first content to the player 410 through the proxy 420.

A third process 443 may be an example of a process in which the player 410 requests the first server 431 for a media playlist through the proxy 420. Here, the media playlist may be selected by the player 410 through the master playlist provided in the second process 442.

A fourth process 444 may be an example of a process in which the first server 431 provides the media playlist to the proxy 420.

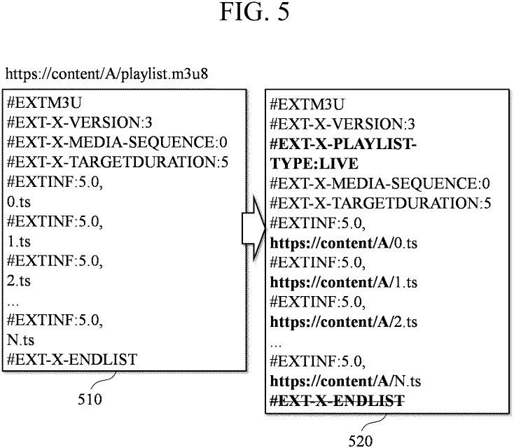

A fifth process 445 may be an example of a process in which the proxy 420 modifies the media playlist provided in the fourth process 444. For example, the proxy 420 may modify the media playlist for VOD-type content to the media playlist for live-type content. Modification of the media playlist is further described with reference to FIG. 5. The VOD-type content may refer to content that is provided by streaming files in a state in which all files for the content are already created. In addition, live-type content may refer to content that is provided by streaming files in a state in which content is being created in real time.

A sixth process 446 may be an example of a process in which the proxy 420 provides the modified media playlist to the player 410. In this case, the player 410 may recognize that the first content is not a VOD-type content but a live-type content. Since the player 410 recognizes the first content as a live-type content, the player 410 may periodically request the media playlist. This uses a feature that the player 410 periodically updates the media playlist for the live-type content. For example, in the live type, content (ts files) within the media playlist may be continuously modified. For example, ts files of 30 to 40-second duration may be included in playlist.m3u8 file at a first point in time “01:00,” ts files of 40 to 50-second duration may be included in the playlist.m3u8 file at a second point in time “01:10,” and ts files of 50 to 60-second duration may be included in the playlist.m3u8 file at a third point in time “01:20.” Therefore, the player 410 may periodically monitor the playlist.m3u8 file to play back the live-type content.

A seventh process 447 may be an example of a process in which the player 410 periodically requests and receives the media playlist to and from the proxy 420 and sequentially requests and receives streaming data to and from the first server 431 through the modified media playlist. As described above, the player 410 may periodically request the media playlist and this request may be processed by the proxy 420 and the modified media playlist may be periodically provided to the player 410 as in the sixth process 446. Also, the player 410 may sequentially receive the streaming data (e.g., 0.ts to N.ts) from the first server 431 according to the modified media playlist.

An eighth process 448 may be an example of a process in which the proxy 420 requests a second server 432 for a master playlist and a media playlist for second content and receives the master playlist and the media playlist for the second content from the second server 432. The eighth process 448 may be performed during the progress of the seventh process 447. That is, before playback of the first content ends, the proxy 420 may receive the master playlist and the media playlist for the second content from the second server 432.

A nineth process 449 may be an example of a process in which the player 410 periodically requests and receives the media playlist to and from the proxy 420 and sequentially requests and receives streaming data to and from the second server 432 through the modified media playlist. When the playback of the first content ends, the proxy 420 may provide the media playlist for the second content to the player 410. Here, the media playlist for the second content may be in a modified state by the proxy 420 as in the fifth process 445. Therefore, the player 410 that receives the modified media playlist may periodically request and receive the media playlist to and from the proxy 420, and may sequentially receive streaming data (e.g., 0.ts to M.ts) from the second server 432 according to the modified media playlist.

That is, from the perspective of the player 410, streaming data may be received and played back in a gapless manner not as two pieces of content but one piece of content received in a gapless manner.

Meanwhile, although it is described in FIG. 4 that two pieces of content are from different servers (the first server 431 and the second server 432), the content playback method according to the example embodiment may also apply to two pieces of content from the same single server.

FIG. 5 illustrates an example of modifying a media playlist to change VOD-type content to live-type content according to an example embodiment. FIG. 5 illustrates an example of modifying a media playlist 510 for VOD-type content to a media playlist 520 for live-type content. A tag representing that a type of the corresponding media playlist 520 is live, such as “#EXT-X-PLAYLIST-TYPE:LIVE,” may be added to the media playlist 520, and a tag “#EXT-X-ENDLIST” may be deleted therefrom. Also, a path of streaming data (ts file) may be changed to an absolute path (full URL). That is, the proxy 420 may modify the media playlist 510 as in the media playlist 520 such that the player 410 may recognize a type of corresponding content as the live type.

In this case, as described above, the player 410 may periodically request a media playlist and, when playback of one piece of content ends, may connect and play back two pieces of content as one piece of content in a gapless manner through a media playlist of subsequent content received from the proxy 420 according to a periodic request.

Meanwhile, although a case of an HLS protocol is described as an example in FIG. 5, it may be easily understood from this description that modifying a media playlist for VOD-type content to a media playlist for live-type content may be applied to other protocols for streaming.

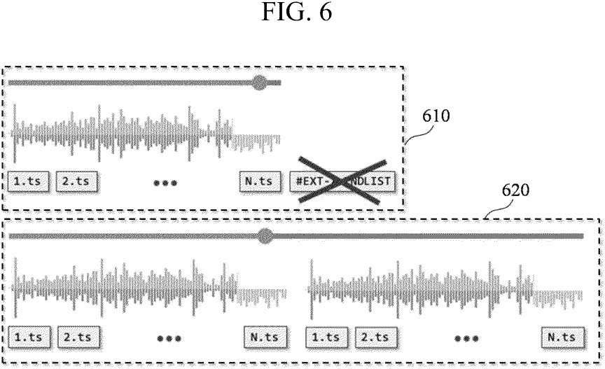

FIG. 6 illustrates an example of two pieces of content connected as one piece of content according to an example embodiment. A first box 610 indicated with dotted lines represents an example in which a tag “#EXT-X-ENDLIST” is removed from a media playlist of first VOD content by the proxy 420. Also, a second box 620 indicated with dotted lines represents an example of connecting a media playlist of subsequent VOD content to the media playlist of the first VOD content from which the tag “#EXT-X-ENDLIST” is removed. Here, the tag “#EXT-X-ENDLIST” may be removed in advance from the media playlist of the subsequent VOD content by the proxy 420.

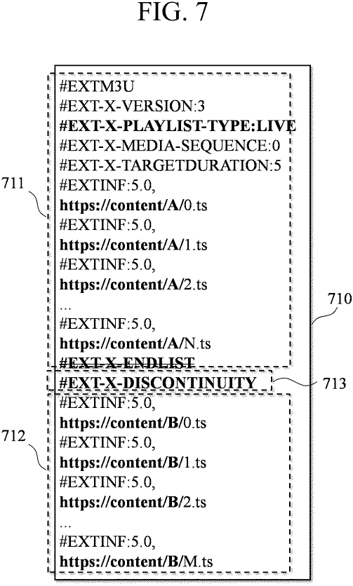

FIG. 7 illustrates an example of a connected media playlist according to an example embodiment. FIG. 7 illustrates an example of a single media playlist 710 in which modified media playlists of two pieces of content are connected. Here, a first box 711 indicated with dotted lines represents contents of a modified media playlist of first content and a second box 712 indicated with dotted lines represents contents of a modified media playlist of second content. Here, as in a third box 713 indicated with dotted lines, change of a timeline may be specified in the media playlist 710 through a tag “#EXT-X-DISCONTINUITY” added between the two contents.

After the playback of the first content ends, the playback of the second content may naturally follow through the expanded media playlist 710. Here, for operation stability in the player 410, the proxy 420 may delete streaming data related to the first content from the media playlist 710 after the playback of the first content ends.

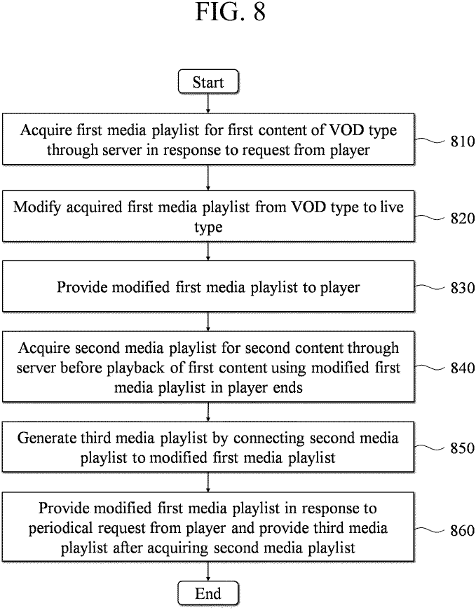

FIG. 8 is a flowchart illustrating an example of a content playback method according to an example embodiment. The content playback method according to the example embodiment may be performed by the computer device 200 that implements the proxy 420. For example, the proxy 420 may be implemented on a user’s terminal device that includes the player 410. In this case, the computer device 200 may correspond to the terminal device (e.g., the electronic device 110, 120, 130 or 140) of the user. Here, the processor 220 of the computer device 200 may be implemented to execute a control instruction according to a code of an OS included in the memory 210 or a code of at least one program. Here, the processor 220 may control the computer device 200 to perform operations 810 to 860 included in the method of FIG. 8 according to a control instruction provided from the code stored in the computer device 200.

In operation 810, the computer device 200 may acquire a first media playlist for first content of VOD type through a server (e.g., server 150 or 160) in response to a request from a player. For example, the player may correspond to the player 410 of FIG. 4. In an example embodiment of FIG. 4, it is described that, as the player 410 requests the first server 431 for the master playlist and the media playlist, the proxy 420 acquires the master playlist and the media playlist.

In operation 820, the computer device 200 may modify the acquired first media playlist from the VOD type to a live type. For example, the computer device 200 may remove a tag (e.g., tag “#EXT-X-ENDLIST” of HLS protocol) representing an end of the first media playlist from the first media playlist and may add a tag (e.g., tag “#EXT-X-PLAYLIST-TYPE:LIVE” of HLS protocol) specifying that the first media playlist is a live type to the first media playlist. Also, the computer device 200 may change a path of streaming data included in the first media playlist with an absolute path that includes a default URL. An example of changing the path of streaming data to the absolute path is described above with reference to FIG. 5.

In operation 830, the computer device 200 may provide the modified first media playlist to the player. The player that receives the modified first media playlist may sequentially request and receive streaming data from a server through the absolute path of streaming data included in the modified first media playlist. Also, as described above, in the live type, content (e.g., ts files of HLS protocol) within the media playlist may be continuously changed. Therefore, in response to receiving the first media playlist modified as the live type, the player may periodically request the first media playlist when playing the first content.

In operation 840, the computer device 200 may acquire a second media playlist for second content through a server before the playback of the first content using the modified first media playlist in the player ends. Here, depending on example embodiments, the server that provides the first media playlist and the server that provides the second media playlist may be different servers.

In operation 850, the computer device 200 may generate a third media playlist by connecting the second media playlist to the modified first media playlist. Here, the computer device 200 may generate the third media playlist that includes the first content of the modified first media playlist and the second content of the second media playlist and may add a tag (e.g., tag “#EXT-X-DISCONTINUITY” of HLS protocol) specifying that a timeline has changed between the first content and the second content. An example of connecting the first media playlist and the second media playlist is described above with reference to FIG. 7.

In operation 860, the computer device 200 may provide the modified first media playlist in response to a periodic request from the player and may provide the third media playlist after acquiring the second media playlist. Here, the absolute path of streaming data included in the second media playlist is included in the third media playlist. Therefore, when playback of the first content ends, the player may play back the second content in a gapless manner.

As described above, according to example embodiments, it is possible to gaplessly play back at least two pieces of content each provided in a streaming manner as one piece of content.

The systems or the apparatuses described herein may be implemented using hardware components or a combination of the hardware components and the software components. For example, the apparatuses and the components described herein may be implemented using one or more computers or processing devices, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, a computer storage medium or device, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in non-transitory computer-readable recording media. The media may include, alone or in combination with program instructions, data files, data structures, and the like. Here, the media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are configured to store program instructions, such as read-only memory (ROM), random access memory (RAM), flash memory, and the like. Examples of other media may include record media and storage media managed by an app store that distributes applications or a site that supplies and distributes other various types of software, a server, and the like. Examples of the program instructions include a machine language code as produced by a compiler and an advanced language code executable by a computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A content playback method performed by a computer device having at least one processor, the method comprising:
acquiring a first media playlist for first content of a video-on-demand (VOD) type through one of a plurality of servers in response to a request from a player;
modifying the acquired first media playlist from the VOD type to a live type;
providing the modified first media playlist to the player;
acquiring, a second media playlist for second content through one of a plurality of servers before playback of first content using the modified first media playlist in the player ends; and
generating a third media playlist by connecting the second media playlist to the modified first media playlist.

2. The content playback method of claim 1, wherein the player is configured to periodically request the first media playlist when playing back the first content upon receiving the first media playlist of the live type.

3. The content playback method of claim 2, further comprising:
providing the modified first media playlist in response to a periodic request from the player and providing the third media playlist after acquiring the second media playlist.

4. The content playback method of claim 1, wherein the modifying of the acquired first media playlist comprises:
removing a tag representing an end of the first media playlist from the first media playlist;
adding a tag specifying that the first media playlist is the live type to the first media playlist; and
changing a path of streaming data included in the first media playlist to an absolute path that includes a default uniform resource locator (URL).

5. The content playback method of claim 1, wherein the third media playlist includes the first content of the modified first media playlist and second content of the second media playlist and a tag specifying that a timeline has changed between the first content and the second content.

6. The content playback method of claim 1, wherein the one of the plurality of servers that provides the first media playlist and the one of the plurality of servers that provides the second media playlist are different servers.

7. A non-transitory computer-readable recording medium storing a computer program for implementing the content playback method according to claim 1 on a computer device.

8. A computer device comprising:
at least one processor configured to execute computer-readable instructions for performing content playback,
wherein the at least one processor is caused to performs the steps including:
acquiring a first media playlist for first content of a video-on-demand (VOD) type through one of a plurality of servers in response to a request from a player,
modifying the acquired first media playlist from the VOD type to a live type,
providing the modified first media playlist to the player,
acquiring a second media playlist for second content through one of a plurality of servers before playback of first content using the modified first media playlist in the player ends, and
generating a third media playlist by connecting the second media playlist to the modified first media playlist.

9. The computer device of claim 8, wherein the player is configured to periodically request the first media playlist when playing back the first content upon receiving the first media playlist of the live type.

10. The computer device of claim 9, wherein the the modified first media playlist is provided in response to a periodic request from the player and the third media playlist is provided after acquiring the second media playlist.

11. The computer device of claim 8, wherein the modifying of the acquired first media playlist comprises:
removing a tag representing an end of the first media playlist from the first media playlist,
adding a tag specifying that the first media playlist is the live type to the first media playlist, and
changing a path of streaming data included in the first media playlist to an absolute path that includes a default uniform resource locator (URL).

12. The computer device of claim 8, wherein the third media playlist includes the first content of the modified first media playlist and second contents of the second media playlist and a tag specifying that a timeline has changed between the first content and the second content.
